(19) United States
(12) Patent Application Publication
(10) Pub. No.: US 2016/0152459 A1
(43) Pub. Date: Jun. 2, 2016

(54) METHOD AND DEVICE FOR FORMING PACKAGING UNITS

(71) Applicant: KHS GmbH, Dortmund (DE)

(72) Inventor: Thomas STIENEN, Unna (DE)

(21) Appl. No.: 14/900,347

(22) PCT Filed: May 7, 2014
(86) PCT No.: PCT/EP2014/001211

§ 371 Date: Dec. 21, 2015

(30) Foreign Application Priority Data
Jun. 19, 2013 (DE) 10 2013 106 421.3

(51) Int. Cl. B67C 3/24; B67C 3/30

(52) U.S. Cl. CPC B67C 3/24; B67C 3/30

(57) ABSTRACT

A method for forming a packaging unit includes producing a container from plastic, filling it with filling product, receiving it in a support structure, and holding it in the support structure, then, while the container is being held, inserting a keg fitting into a mouth of the container.

### RELATED APPLICATIONS

This application is the national stage under 35 USC 371 of international application PCT/EP2014/001211, filed on May 7, 2014, which claims the benefit of the Jun. 19, 2013 priority date of German application DE 10 2013 106 421.3, the contents of which are herein incorporated by reference.

### FIELD OF INVENTION

The invention concerns container handling, and in particular, handling large containers.

### BACKGROUND

Bulk storage containers for liquids are known. These containers, often called “kegs,” are normally used for filling with beer and lemonade. Such kegs are very large. Although twenty liter kegs are most common, it is not uncommon to encounter kegs having volumes of as little as five liters or as much as fifty liters etc. Although kegs have historically been made of metal, single-use kegs made of plastic have become common. These are often called “PET kegs.”

Manufacturing a packaging unit typically involves making the keg from plastic, and suspending it from a flange formed in the keg. While suspended, the keg is filled with the filling product. After being filled, with the keg still suspended from its flange, a keg fitting is inserted into the keg's mouth.

The connection between the keg and its keg fitting is preferably very tight. Achieving a tight connection typically includes pressing the keg fitting into the container mouth. This requires the region around the container mouth to absorb considerable force.

Suspending a keg from its flange in a predefined orientation assumes that sufficient space is available along guide elements for the container carrier. This is not guaranteed at all locations.

In addition, suspended containers and guide elements, are associated with significant mechanical-technical complexity, for example if the container is transported around corners.

### SUMMARY

The invention provides a simpler way of forming packaging units, each of which comprises a container closed with a keg fitting and filled with a filling product.

To solve this problem, a method for forming packaging units, each of which includes a container, in particular a bulk storage container, for example a keg, closed with a keg fitting and filled with filling product includes receiving and holding such a container in a supporting structure at least while inserting and connecting the keg fitting in the container's mouth, and in some practices of the invention, also while filling it with the filling product.

This differs from prior art solutions, in which the container is suspended from its flange. In the present method, it is the ground that supports the container, with assistance from the supporting structure.

The supporting structure dissipates any forces occurring during the insertion and connection of the keg fitting. The supporting structure achieves this by lying against the periphery and base of the container. This means that the supporting structure provides rest and support for the container on its periphery and on its base. In contrast, the container mouth is usually free from the supporting structure so that the container can easily be filled with the filling product.

Only after the filling has been introduced is the keg fitting finally supplied, introduced into the container's mouth, and tightly connected to the container. In some practices, this tight connection is created and achieved by pressing the keg fitting into the container mouth. However, other connection methods are included in the scope of the invention.

A plastic container is generally produced and prepared by blow molding. The filling product is introduced into the container immediately after the container has been molded. An opening is thus available in the region of the container mouth, the full opening cross section of which can be used for the filling process. The necessary keg fitting is only introduced into the container mouth and tightly connected thereto at the end, when the container has already been filled.

For the supporting structure to effectively absorb all forces occurring in handling of the container to dissipate these into an associated base, the supporting structure is designed such that, where applicable in connection with at least one additional element on or in the supporting structure, it can absorb any axial and/or radial forces occurring while the keg fitting is being connected to the container mouth. This means that at least one additional element on or in the supporting structure ensures that forces typically occurring on connection of the keg fitting to the container mouth can be absorbed and usually dissipated via the additional element into the supporting structure, and from there into a base receiving the supporting structure. This base can generally be a transport element that transports individual containers from one station to another.

In some embodiments, a first station is a blow-molding machine that makes the containers from plastic. The second station is a filling element or filling machine. A subsequent third station is a connecting station at which the keg fitting is supplied, inserted in the container mouth, and tightly connected to the container mouth. This can take place, as already explained, by pressing the keg fitting.

The additional element absorbs forces occurring on connection of the keg fitting to the container mouth. The additional element then dissipates these forces into the supporting structure and from there into the base or into one or more transport elements. The forces occurring in the region of the container mouth may be axial and/or radial forces. This means that the process of connecting the keg fitting to the container mouth results in forces that act on the container in the axial direction, i.e. in the longitudinal direction. Alternatively or additionally however, forces may act in the radial direction i.e. radial relative to the container axis. In any case the additional element in or on the supporting structure advantageously ensures that these axial and/or radial forces concerned are absorbed and dissipated via the supporting structure.

To avoid having the additional element interfere with handling the container, the additional element is configured to extend and retract. When retracted, the additional element allows the container to be placed in the supporting structure. In some practices, the container is inserted in the supporting structure from above. However, in other practices, the supporting structure is brought up to the container from the base. In either case, the additional element is retracted.

In contrast, when extended, the additional element supports the container, and in particular, its container mouth.

The additional element can advantageously be formed as an inflatable collar, a moveable supporting finger structure, or any similar structure.

As a whole, the configuration is such that the additional element extends only when the container is filled with the filling product. This means that the additional element extends only in the connecting station when the keg fitting is being supplied, inserted in the container mouth, and finally tightly connected to the container. This ensures firstly that the process of producing the container is disrupted as little as possible by the additional element, as is the immediately following filling process.

During the filling process, the filling product is introduced into the container from above through the container opening. The filling product can be a liquid, a slurry, or a powdery or granular filling product. Common filling materials include beer, ale, and lemonade.

In one aspect, the invention features a method for forming a packaging unit that includes a container filled with filling product. Such a method includes producing a container from plastic, filling it with filling product, receiving it into a supporting structure, and, while the container is being held in the supporting structure, inserting a keg fitting into its mouth.

In some practices, receiving the keg occurs prior to filling the container, and filling the container comprises filling the container while the container is being held by the supporting structure.

Other practices include those in which producing the container from plastic comprises producing a keg from plastic.

Yet other practices include causing the supporting structure to dissipate forces occurring while inserting the keg fitting into the mouth.

Practices include those in which holding the container in the supporting structure includes causing the supporting structure to hold the container at points along a periphery of the container, to support a base of the container, and to support forces associated with the container and the filling product.

In other practices, holding the container in the support structure includes causing the support structure and an additional element coupled to the support structure to absorb forces arising while inserting the keg fitting into the mouth. These forces can be axial or radial.

Some practices of the invention include either extending or retracting an additional element coupled to the support structure to absorb forces arising while inserting the keg fitting into the mouth. Among these practices are those that include retracting the additional element to enable the container to be placed in the support structure and extending the additional element to enable the additional element to support the mouth.

Some practices of the invention include coupling an additional element to the support structure to absorb forces arising while inserting the keg fitting into the mouth. This additional element can include a variety of structures, among which are an inflatable collar and a supporting finger structure.

In another aspect, the invention features an apparatus for forming packaging units, each of which comprises a container filled with filling product and closed with a keg fitting. Such an apparatus includes a filling element for receiving a plastic container and filling the plastic container with filling product, a connecting station for inserting a keg fitting into a mouth of the container and tightly connecting the keg fitting to the mouth, and a support structure disposed in the connecting station for receiving and holding the container while the keg fitting is inserted into a mouth thereof.

Alternative embodiments further include a blow-molding machine for producing the plastic container.

Another object of the invention is a device for forming packaging units, which in particular is configured and suitable for performance of the method described. The invention is explained in more detail below with reference the accompanying figures, in which:

### BRIEF DESCRIPTION OF THE DRAWINGS

FIG. 1 is an overview of a device according to the invention, and

FIG. 2 shows a support structure used for a container processed by the device shown in FIG. 1.

### DETAILED DESCRIPTION

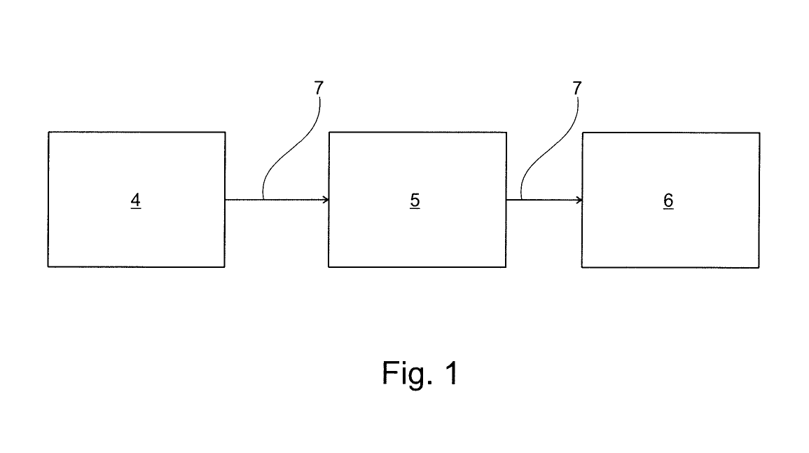

FIG. 1 shows a packaging unit that includes a container 1 and a keg fitting 3 that is inserted into the container 1 through a mouth 2 thereof. The keg fitting 3 is tightly connected to the container 1. To achieve this tight fit, the keg fitting 3 is normally pressed into the mouth 2.

The process for supplying the keg fitting 3, inserting it into the container's mouth 2, and finally the pressing of the keg fitting 3 into the container mouth 2 takes place in a connecting station 6 shown in FIG. 1.

In addition to the connecting station 6, the apparatus shown in FIG. 1 includes a blow-molding machine 4 and a filling machine 5.

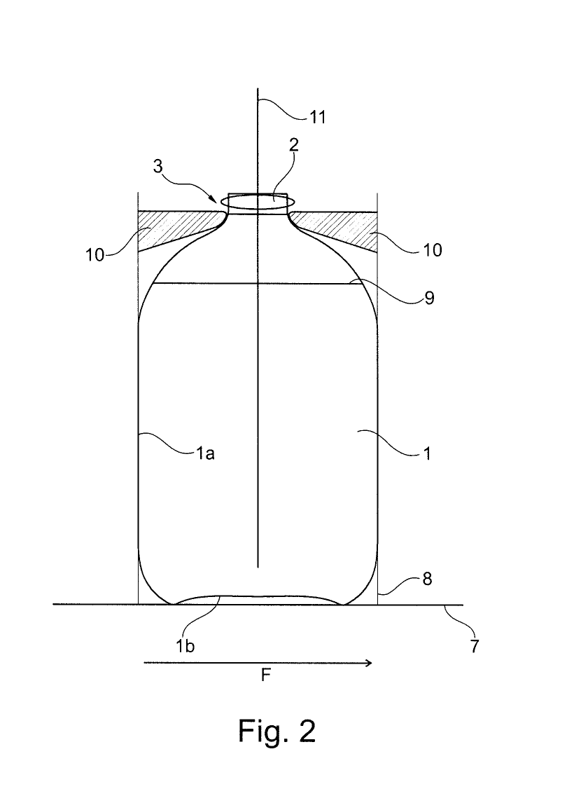

Transport devices 7 connect the blow-molding machine 4 to the filling machine 5 and the filling machine 5 to the connecting station 6. In the illustrated embodiment, the transport device 7 includes conveyor belts that transport containers along a transport direction F, as shown in FIG. 2.

The blow-molding machine 4 forms containers 1 by blowing a preform. The filling machine 5, which immediately follows the blow-molding machine 4, fills the container 1 with filling product 9. Typical filling products include beer or lemonade.

After the containers 1 have been filled in the filling machine 5, the transport device 7 brings them to the connecting station 6. At the connecting station 6, the keg fitting 3 is supplied, inserted in the mouth 2, and tightly connected to the container mouth 2 and consequently to the container 1. This includes pressing the keg fitting 3 into the mouth 2.

While the container 1 is in the connecting structure 6, and/or while the keg fitting 3 is being inserted into the container 1, a support structure 8, shown in FIG. 1, supports the container 1. The support structure 8 is shaped to match the outer contour of the container 1. In the case of a cylindrical container, the support structure 8 is a hollow cylinder or one or more sections of a hollow cylinder. In either case, the support structure 8 has a diameter that corresponds to the container's diameter.

The support structure 8 supports the container 1 at its periphery 1a and at its base 1b. As a result, the support structure 8 absorbs the various forces exerted by the filling product on the container. These forces include weight and hydrostatic pressure. Without such support, these forces would tend to make a plastic container bow outward to form a convex fashion at its periphery 1a. Such forces can be absorbed by means of the support structure 8. The same applies to deformations of the base 1b because of the filled liquid 9.

The support structure 8 includes an additional element 10 for supporting the container. In the illustrated embodiment, the additional element 10 is a collar or circular ring that can be inflated with air or nitrogen. Inflation causes the additional element 10 to transition from a retracted position to an extended position.

When inflated into its extended position, as shown in FIG. 2, the additional element 10 forms a ring that surrounds and supports the container mouth 2. When in its retracted state, the additional element 10 lies against the support structure 8.

In the particular embodiment in which the additional element 10 is an inflatable structure, the support structure 8 includes supply lines for pressurizing and depressurizing the additional structure 10.

When the additional element 10 is retracted, the support structure 8 can receive the container 1. In particular, the support structure 8 receives the container 1 from above. Alternatively, the support structure 8 is pushed over the container 1 from its base 1b. In both cases, the additional element 10, being in its retracted position, does not hinder the container's entry into the support structure 8.

The additional element 10 is activated only when the container 1 is available after production, following blow molding in the blow-molding machine 4 and filling with the filling product at the filling machine 5. In particular, the additional element 10 is extended state when the keg fitting 3 is supplied, inserted into the mouth, and tightly connected thereto in the connecting station 6. In this stage, the additional element 10 absorbs forces occurring during insertion of the keg fitting 3 into the mouth, and in particular, during connection of the keg fitting 3.

The additional element 10 absorbs both axial forces and radial forces.

Axial forces are directed in the longitudinal direction of the container 1. In the exemplary embodiment, shown in FIG. 2, a riser pipe 11 extending along an axis of the container 2 indicates the longitudinal direction. The riser pipe 11 is anchored in or forms part of the keg fitting 3. Radial forces, in contrast, are forces that act in a direction perpendicular to the longitudinal direction.

The additional element 10 dissipates both the axial forces and the radial forces into the support structure 8 and finally into the transport device 7.

Normally, after the blow-molding machine 4 manufactures the container 1 but before the filling machine 5 fills it, the container is transferred directly to the support structure 8. This means that container 1 and support structure 8 are combined either on transfer from the blow-molding machine 4 to the filling machine 5 or at the input side of the filling machine 5.

In some practices, the container 1 is transferred into the support structure 8 only after the container 1 has already been filled with filling product. This can occur, for example, at the output of the filling machine 5 or during a transition from the filling machine 5 to the connecting station 6. These practices are disadvantageous because the container 1, having already been filled with filling product, is rather heavy. Since it is usually easier to handle the container 1 when it is light, it is preferable to deploy the support structure 8 with the container still empty.

Having described the invention, and a preferred embodiment thereof, what is claimed as new, and secured by letters patent is:

1-10. (canceled)

11. A method comprising producing a container from plastic, filling said container with filling product, receiving said container in a support structure, holding said container in said support structure, and, with said container held in said support structure, inserting a keg fitting into a mouth of said container.

12. The method of claim 11, wherein receiving said keg occurs prior to filling said container, and wherein filling said container comprises filling said container while said container is being held by said support structure.

13. The method of claim 11, wherein producing said container from said plastic comprises producing a keg from said plastic.

14. The method of claim 11, further comprising causing said support structure to dissipate forces occurring while inserting said keg fitting into said mouth.

15. The method of claim 11, wherein holding said container in said support structure comprises causing said support structure to hold said container at points along a periphery of said container, to support a base of said container, and to support forces associated with said container and said filling product.

16. The method of claim 11, wherein holding said container in said support structure comprises causing said support structure and an additional element coupled to said support structure to absorb forces arising while inserting said keg fitting into said mouth.

17. The method of claim 16, wherein said forces comprise axial forces.

18. The method of claim 16, wherein said forces comprise radial forces.

19. The method of claim 16, further comprising at least one of extending and retracting said additional element.

20. The method of claim 16, further comprising retracting said additional element to enable said container to be placed in said support structure and extending said additional element to enable said additional element to support said mouth.

21. The method of claim 14, wherein said additional element comprises an inflatable collar.

22. The method of claim 16, wherein said additional element comprises a supporting finger structure.

23. The method of claim 16, further comprising inflating said additional element.

24. An apparatus for forming packaging units, each of which comprises a container filled with filling product and closed with a keg fitting, said apparatus comprising a filling element for receiving a plastic container and filling said plastic container with filling product, a connecting station for inserting a keg fitting into a mouth of said container and tightly connecting said keg fitting to said mouth, and a support structure disposed in said connecting station for receiving and holding said container while said keg fitting is inserted into a mouth thereof.

25. The apparatus of claim 24, further comprising a blow-molding machine for producing said plastic container.
